(19) United States
(12) Patent Application Publication
(10) Pub. No.: US 2022/0338460 A1
(43) Pub. Date: Oct. 27, 2022

(54) MOUSETRAP

(71) Applicant: HONGQIN LIU, SHENZHEN CITY, GUANGDONG PROVINCE (CN)

(72) Inventor: YUXIA MIAO, HANZHONG CITY, SHANXI PROVINCE (CN)

(21) Appl. No.: 17/432,140

(22) PCT Filed: Aug. 3, 2021
(86) PCT No.: PCT/CN2021/110398

§ 371 Date: Aug. 19, 2021

(30) Foreign Application Priority Data
Oct. 13, 2020 (CN) 202022259313.2

(51) Int. Cl. A01M 23/02; A01M 23/38; A01M 23/18

(52) U.S. Cl. CPC A01M 23/02; A01M 23/38; A01M 23/18

(57) ABSTRACT

Disclosed is a mousetrap, comprising: a bottom shell, an upper cover, wherein the bottom shell comprises a bottom plate, a first side plate, a second side plate, and a first end plate; two or four killing plates arranged in the bottom shell, wherein a second end plate is provided at the other end of the bottom shell; at least one entrance provided inside the first side plate or the second side plate, and a baffle is provided on the inner surface of the first side plate or the second side plate, a hinged end of the baffle is provided with an elastic member, a supporting assembly linked with the first killing plate is arranged in the bottom shell; when the entrances are in an open state, a lower surface of a side edge of the baffle adjacent to the supporting assembly is supported by the supporting assembly.

### FIELD OF THE DISCLOSURE

The present disclosure relates to the technical field of mousetraps, in particular to a mousetrap with higher safety for catching and killing various harmful small animals.

### BACKGROUND OF THE DISCLOSURE

A mousetrap is a device used to catch harmful small animals such as mice. The mousetrap currently used includes a shell, and at least two killing plates (a positive plate and a negative plate) arranged in the shell. In order to introduce mice into the shell and kill them through the killing plates, one end of the shell is provided with an opening. The mouse enters the shell along a straight passage from the opening and walks to the killing plates. When the mouse's body part is in contact with the positive plate and the negative plate at the same time, the killing plates are activated, and the mouse is given an electric shock to kill to die. By using this type of mousetrap, the end of the shell is provided with an opening, through which the hand can be directly inserted into it. For infants and young children who lack safety awareness, if the hand is inserted into the shell and connected with the positive plate and the negative plate, it will cause great harm to infants and young children. Therefore, this type of mousetrap poses a greater safety hazard; secondly, after the mouse enters the shell and suffers the first electric shock, if it has the ability to move, it may follow a straight passage to retreat and flee, and the effect of catching rats will be poor.

### SUMMARY OF THE DISCLOSURE

In order to overcome the shortcomings of the prior art, the purpose of the present disclosure is to provide a mousetrap with higher safety.

In order to achieve the above objective, the technical solution adopted by the present disclosure is to provide a mousetrap, comprising: a bottom shell, an upper cover, wherein the bottom shell comprises a bottom plate, a first side plate, a second side plate, and a first end plate; two or four killing plates arranged in the bottom shell, wherein a second end plate is provided at the other end of the bottom shell; at least one entrance, wherein the entrance is provided inside the first side plate or the second side plate, and a baffle is provided on the inner surface of the first side plate or the second side plate, a hinged end of the baffle is provided with an elastic member, a supporting assembly linked with the first killing plate is arranged in the bottom shell; when the entrance is in an open state, a lower surface of a side edge of the baffle adjacent to the supporting assembly is supported by the supporting assembly.

Beneficial technical effect of the present disclosure is that: an entrance is provided in one of the side plates or two side plates of the bottom shell, so, if infants and young children accidentally stretch their hands into the bottom shell, they cannot directly reach the first killing plate like the existing mousetrap, but need to make the hands turn to reach the first killing plate, which is difficult for infants and young children. Therefore, safety hazards are eliminated. When the mouse enters the bottom shell, the baffle rotates relative to the first side plate or the second side plate, and finally the entrance is closed to prevent mice from escaping from the bottom shell. Compared with the mousetrap of the prior art, the present disclosure has high safety and a high success rate of mousetrap.

### BRIEF DESCRIPTION OF THE DRAWINGS

In order to explain the embodiments of the present disclosure or the technical solutions in the prior art more clearly, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative labor.

FIG. 1 is an exploded view of a partial structure of an embodiment of the present disclosure.

FIG. 2 is an exploded view from another angle of the partial structure of the embodiment of the present disclosure.

FIG. 3 is an exploded view of an embodiment of the present disclosure.

FIG. 3A is a first partial enlarged view of FIG. 3.

FIG. 3B is a second partial enlarged view of FIG. 3.

FIG. 3C is a third partial enlarged view of FIG. 3.

FIG. 4 is an exploded view from another angle of the embodiment of the present disclosure.

FIG. 5 is a perspective view of an embodiment of the present disclosure.

FIG. 6 is a cross-sectional view of the open state of the entrance of the embodiment of the present disclosure.

FIG. 7 is a cross-sectional view of the closed state of the entrance of the embodiment of the present disclosure.

FIG. 8 is a schematic diagram of assembly of a main body and a controller according to an embodiment of the present disclosure.

FIG. 9 is a perspective view of the embodiment of the present disclosure when the upper cover is removed.

FIG. 10 is a perspective view of a controller according to an embodiment of the present disclosure.

FIG. 11 is a perspective view of the upper cover of the embodiment of the present disclosure.

FIG. 12 is a circuit diagram of an embodiment of the present disclosure.

FIG. 13 is a schematic diagram of another embodiment of the present disclosure with the upper cover and the baffle removed.

### DETAILED DESCRIPTION OF THE EXEMPLARY EMBODIMENTS

In order to enable those skilled in the art to better understand the solution of the present disclosure, the present disclosure will be further described in detail below with reference to the accompanying drawings and embodiments.

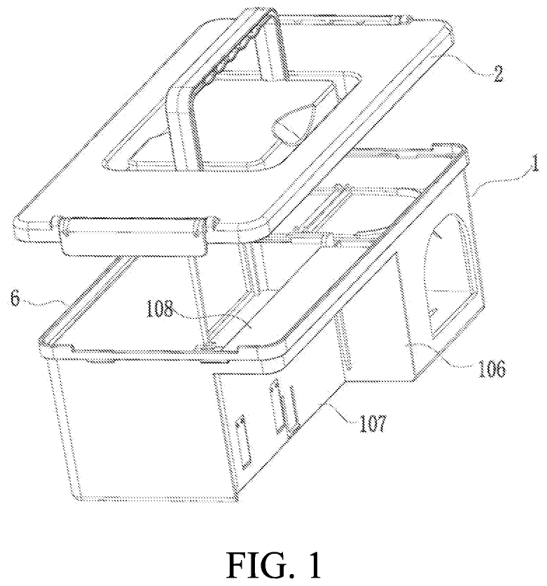

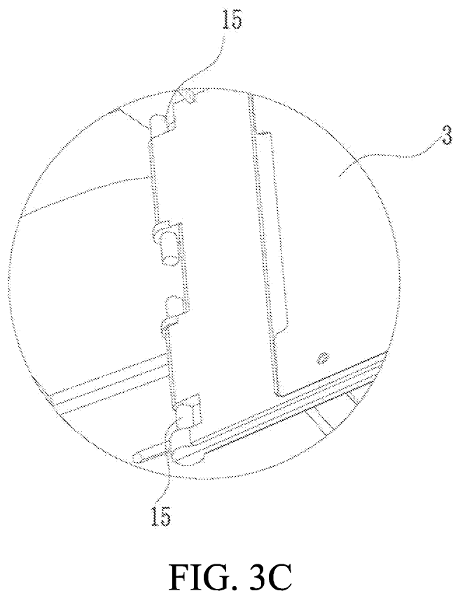

As shown in FIGS. 1-5, an embodiment of the present disclosure provides a mousetrap, which includes a bottom shell 1, an upper cover 2 provided on the bottom shell 1, and the bottom shell 1 includes a bottom plate 101, a first side plate 102, a second side plate 103 and a first end plate 104 arranged at one end of the bottom shell 1. The bottom shell 1 is provided with a first killing plate 3 and a second killing plate 4 on the bottom plate 101, and a second end plate 105 is arranged on the other end of the bottom shell 1, that is, both ends of the bottom shell 1 are not provided with openings.

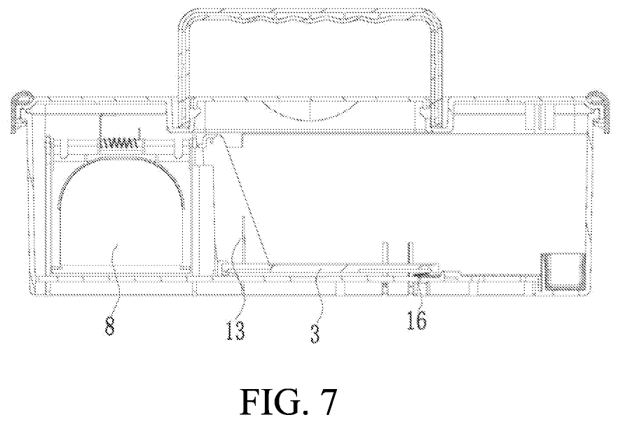

As shown in FIG. 8, in order to have both electric shock killing and mechanical trapping methods, a detachable controller 5 is provided on one side of the bottom shell 1. For this reason, a recessed accommodating part for installing the controller is provided on one side of the bottom shell 1. The accommodating part includes an inner end plate 106 of which an outer end is connected with an end of the second side plate 103; an inner side plate 107 of which both ends are respectively connected with an inner end of the inner end plate 106 and the first end plate 104; and an upper horizontal plate 108 extending outward from the upper edge of the inner side plate 107. Here, the second side plate 103 and the inner side plate 107 form a combined side plate having the same length as the first side plate 102, and the distance between the inner side plate 107 and the first side plate 102 is smaller than that of the first side plate 102 and the second side plate 103. Therefore, the bottom plate 101 is also composed of two parts, which are the part between the first side plate 102 and the second side plate 103 and the part between the first side plate 102 and the inner side plate 107, which are used to install the first killing plate 3 and the second killing plate 4; that is, the inner end plate 106, the inner side plate 107, and the upper horizontal plate 108 are enclosed to form an accommodating part for installing the controller 5, so that the outer surface of the controller 5 does not protrude from the outer surface of the corresponding position of the bottom shell 1, and the contour lines of the mousetrap are smooth and more beautiful.

A connecting ring body 6 is also provided at the upper end opening of the bottom shell 1, and the connecting ring body 6 is integrally formed with the bottom shell 1. The connecting ring body 6 is mainly used for detachably connecting with the upper cover.

The first killing plate 3 and the second killing plate 4 are located between the inner side plate 107 and the first side plate 102 and are detachably connected with the bottom plate 101. That is, the first killing plate 3 and the second killing plate 4 are removable. When the first killing plate 3 and the second killing plate 4 are soiled by mouse urine and other body fluids, they can be removed and cleaned to avoid peculiar smell left in the bottom shell 1 to affect the effect of trapping mice.

Generally, the bottom shell 1 is made of plastic, and its molding process is generally injection molding. The bottom shell 1 is composed of a bottom plate 101, a first side plate 102, a second side plate 103, a first end plate 104, a second end plate 105, an inner end plate 106, an inner side plate 107 and an upper horizontal plate 108, which are integrally formed.

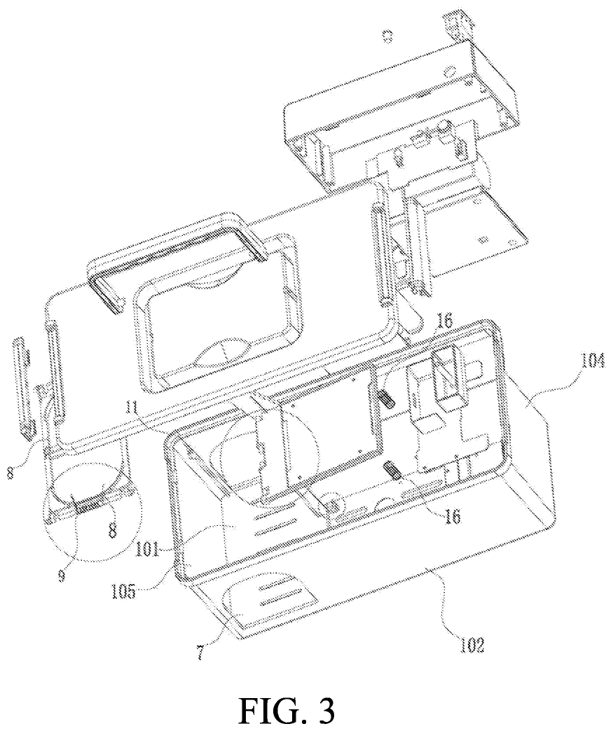

As shown in FIG. 3, this embodiment takes two entrances as an example for description. The two entrances 7 are respectively provided in the first side plate 102 and the second side plate 103. In order to close or open the two entrances 7, a baffle 8 which can rotate relative to the entrance 7 is respectively and correspondingly provided on the inner surface of the first side plate 102 and the inner surface of the second side plate 103. In other words, if only one entrance is provided, when the entrance 7 is provided in the first side plate 102, a baffle 8 needs to be provided on the inner surface of the first side plate 102; and when the entrance 7 is provided inside the second side plate 103, a baffle 8 needs to be provided on the inner surface of the second side plate 103.

The two baffles 8 are respectively hinged to the first side plate 102 and the second side plate 103, and the hinged ends of the baffle 8 are each provided with an elastic member 9 that drives the baffle 8 to rotate and close the entrance 7. Here, when the entrance is opened, the elastic member 9 is in a state of being squeezed. Therefore, the elastic member 9 is mainly used to drive the baffle 8 to rotate, and finally close the entrance 7. The two baffles 8 of this embodiment adopt the same structure.

As shown in FIGS. 3-5 and 3A, in this embodiment, in order to install the baffle 8, a connecting column 10 is provided on both sides of the hinged ends of the two baffles 8, connecting vertical plates 11 are respectively provided at a corresponding position on the inner surface of the first side plate 102 and on the inner surface of the second side plate 103, each connecting vertical plate 11 is provided with a transverse shaft hole 1101 for inserting with the connecting column 10, and the hinged end of the baffle 8 is located between the two connecting vertical plates 11; that is, the inner surfaces of the first side plate 102 and the second side plate 103 are each provided with two parallel connecting vertical plates 11 for hinged connection with the two baffles 8 respectively.

In order to install the elastic member 9, the hinged ends of the two baffles 8 are each provided with two crossbars 12 located on the same straight line and fixedly connected with the baffle 8, and a gap is between the two crossbars 12. Here, the elastic member 9 is a torsion spring with two ends respectively sleeved on the two crossbars 12 and the two ends of the elastic member 9 shown are provided with torsion arms 901. When the entrances 7 are opened, one of the torsion arms 901 on the two torsion springs respectively contacts the inner surfaces of the first side plate 102 and the second side plate 103 and the torsion arm 901 is squeezed, and the reaction force generated by the torsion arm drives the baffle 8 to rotate until the two baffles 8 are respectively attached to the inner surfaces of the first side plate 102 and the second side plate 103 and close the entrance 7.

During use, when the mousetrap is placed indoors or outdoors, in order to allow mice to enter the bottom shell 1, the entrance 7 should be in a normally open state, that is, the free end of the baffle 8 should be raised to not block the entrance 7 and does not affect the entry of mice into the bottom shell 1. For example, the baffle 8 is in a horizontal state. At this time, in order to prevent the baffle 8 from closing the entrance 7 under the reaction force of the torsion arm, it is necessary to provide a supporting surface for the baffle 8.

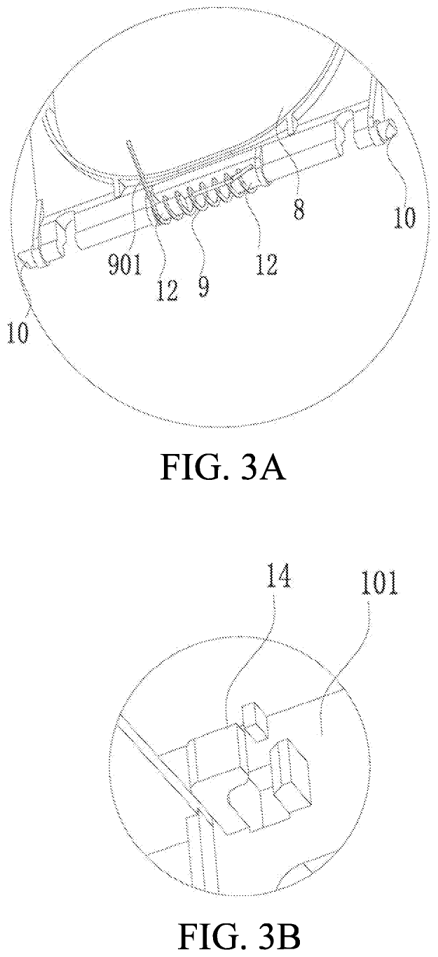

As shown in FIG. 4, in order to provide a supporting surface for the baffle 8, the bottom shell 1 is provided with a supporting assembly 13 linked with the first killing plate 3. Specifically, the supporting assembly 13 comprises a vertical plate 1301, a supporting horizontal block 1302 fixedly connected with an upper end of the vertical plate 1301, a lateral convex strip 1303 provided on a side wall of the supporting horizontal block 1302, and a lower end of the vertical plate 1301 is fixedly connected with an end of the first killing plate 3 adjacent to the entrance 7 and the end on the first killing plate 3 is also the hinged end where the first killing plate 3 hinges with the bottom plate 101. When the entrances 7 are opened, lower surfaces of the side edges of the two baffles 8 adjacent to the supporting horizontal block 1302 are placed on an upper surface of the lateral convex strip 1303. That is, the baffle 8 at this time is supported by the lateral convex strip 1303. The supporting assembly 13 is integrally formed.

Here, the first killing plate 3 and the bottom shell 1 used should be movably connected. For example, the two can rotate relative to each other. When the first killing plate 3 moves relative to the bottom shell 1, the supporting assembly 13 can be moved to embody the linkage between the supporting assembly 13 and the first killing plate 3, thus causing the baffle 8 to lose support and close the entrance 7. The specific structure adopted in this embodiment is that the first killing plate 3 and the bottom plate 101 are hinged, in order to embody the hinged connection between the two, the bottom plate 101 is provided with two bases 14, two connecting shafts 15 are provided on a hinged end where the first killing plate 3 and the bottom shell 1 are hinged, and the two connecting shafts 15 are respectively hinged with the two bases 14. Here, the two connecting shafts 15 and the two bases 14 are detachably connected, as shown in FIG. 3, FIG. 3B, and FIG. 3C.

The hinged connection of the first killing plate 3 and the bottom plate 101 is also equivalent to the hinged connection of the first killing plate 3 to the bottom shell 1. Obviously, the first killing plate 3 can also be hinged to the first side plate 102 and the inner side plate 107, namely, the two bases 14 are respectively arranged on the first side plate 102 and the inner side plate 107, and the same effect can also be achieved.

When the mouse enters the bottom shell 1 and steps on the first killing plate 3, the position of the free end of the first killing plate 3 will naturally drop. At this time, the first killing plate 3 rotates relative to the bottom plate 101 and the supporting assembly 13 moves accordingly. Because the contact surface between the baffle 8 and the lateral convex strip 1303 is very small, when the supporting assembly 13 has a small rotation range, the baffle 8 is separated from the lateral convex strip 1303, and in order to eliminate the pressure at the free end of the first killing plate 3 and return to the initial position, and then drive the supporting assembly 13 to back to the original position and provide support for the baffle 8, the first killing plate 3 needs to be provided with a reset structure.

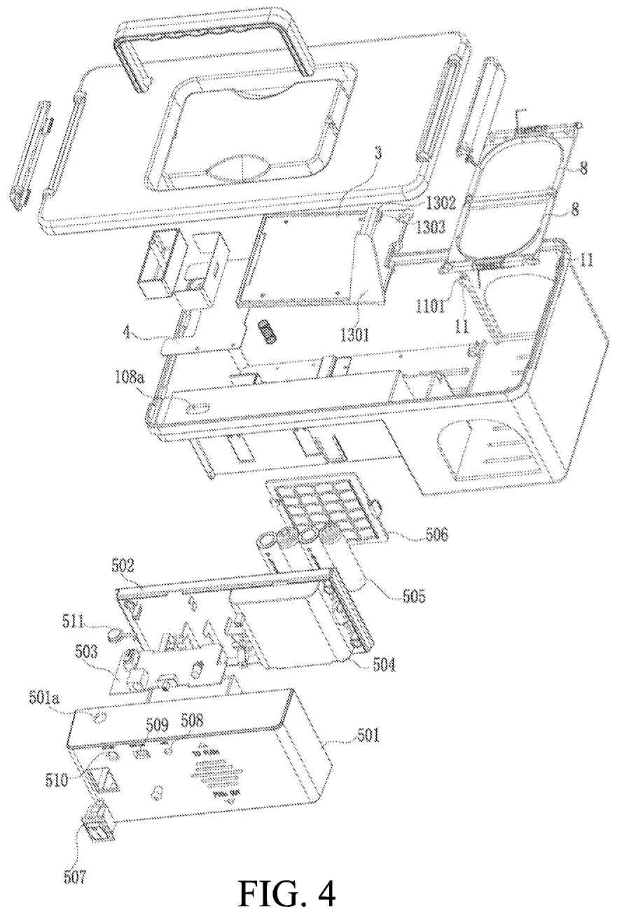

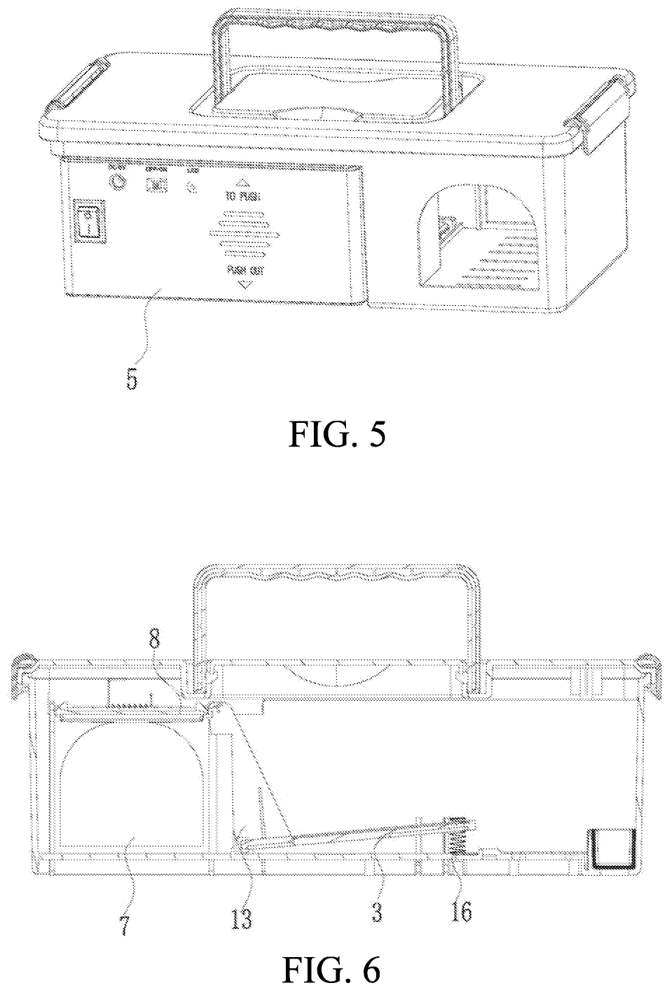

For this reason, as shown in FIGS. 6-7, the bottom shell 1 is provided with a first elastic member 16 connected with the first killing plate 3 for resetting the first killing plate 3 and supporting the other end of the first killing plate 3. Specifically, the first elastic member 16 is two springs, the lower end of the first elastic member 16 is fixedly connected with the bottom plate 101, and the upper end of the first elastic member 16 is connected with the bottom surface of the first killing plate 3. The first elastic member 16 is located inside the hinged end of the first killing plate 3.

As shown in FIG. 8, two sets of elastic contacts 17 are further provided on the outer wall of the inner side plate 107, and the two sets of elastic contacts 17 are electrically connected with the first killing plate 3 and the second killing plate 4 respectively.

The controller 5 is located in an inner concave portion and detachably connected with the inner side plate 107.

Specifically, the controller 5 comprises a shell 501, a cover plate 502 arranged in the shell 501, a circuit board 503 and a battery box 504 arranged on the cover plate 502, a battery 505 arranged in the battery box 504, and a battery box cover plate 506 arranged at an opening of the battery box 504. A power switch 507, an indicator light 508, a sound switch 509, and a DC input hole 510 that are electrically connected with the circuit board 503 are provided on the panel of the shell 501, as shown in FIG. 4.

An upper panel of the shell 501 is provided with a perforation 501a, a safety switch 511 is arranged on the circuit board 503, and an upper end of the safety switch 511 is located in the perforation 501a.

Corresponding to the safety switch 511, the upper horizontal plate 108 is provided with a mounting hole 108a, and the perforation 501a is located directly below the mounting hole 108a, as shown in FIG. 4.

As shown in FIG. 8, in order to embody the detachable connection between the controller 5 and the inner side plate 107, both ends of the cover plate 502 are provided with a sliding rail 502a integrally formed with the cover plate 502, and an inclined guide surface 502b is provided at an upper end of the sliding rail 502a.

Corresponding thereto, two end surfaces of the inner side plate 107 are respectively provided with a sliding groove 107a combined with two sliding rails 502a, and an inner surface of a lower end of an outer barrier strip 107b of the sliding groove 107a is provided with an inclined surface 107c conform to the inclined guide surface 502b.

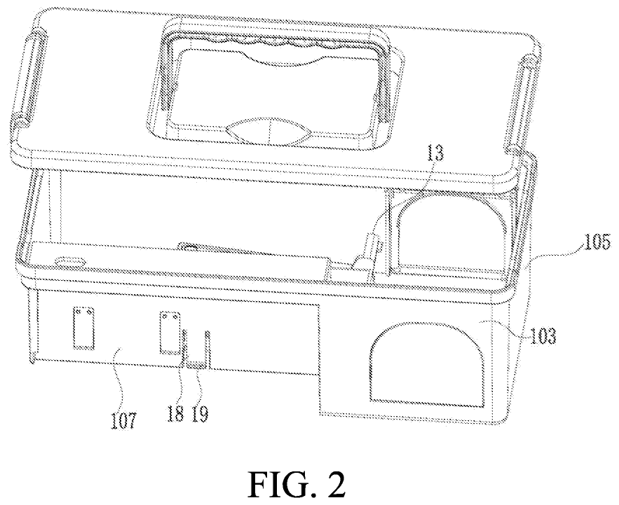

As shown in FIG. 2, a buckle plate 18 of which an upper end is fixedly connected with the inner side plate 107 is provided in the inner side plate 107, two sides and a lower end of the buckle plate 18 are separated from the inner side plate 107, a lower end surface of the buckle plate 18 is flush with a lower surface of the inner side plate 107 and a fastener 19 is arranged on a lower end surface of the buckle plate 18. The buckle plate 18 and the fastener 19 are integrally formed.

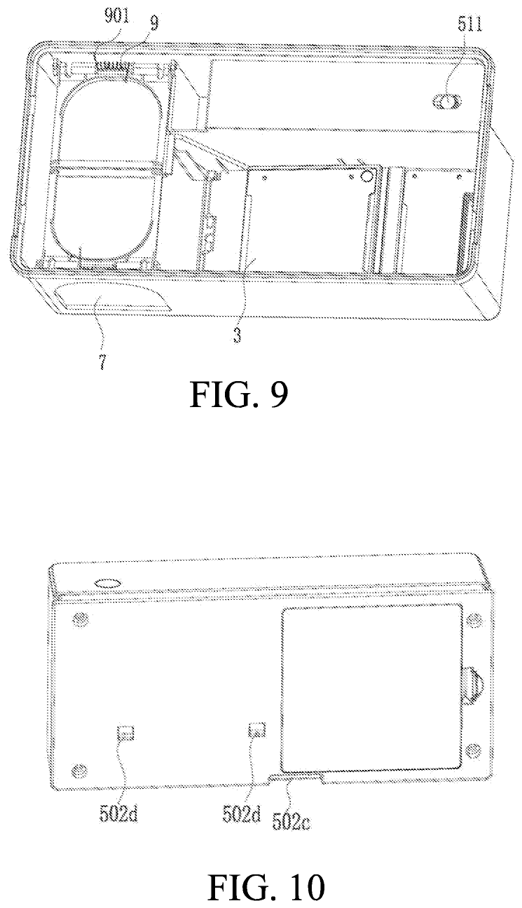

As shown in FIG. 10, a lower edge of the cover plate 502 is provided with a buckle notch 502c connected with the fastener 19.

Two contact holes 502d are provided in the cover plate 502, which are respectively used to make the two sets of elastic contacts 17 extend into the shell 501 to be electrically connected with the circuit board 503.

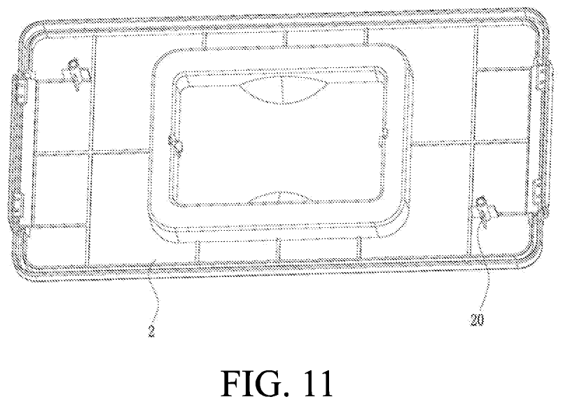

As shown in FIG. 11, furthermore, an inner surface of the upper cover 2 is provided with two guide columns 20 which are vertical to the inner surface, and when the upper cover 2 is combined with the bottom shell 1, a lower end of one of the guide columns 20 passes through the mounting hole 108a and presses the safety switch 511. With this structure, if the upper cover 2 and the bottom shell 1 are not combined together, that is, when the safety switch 511 is not opened by the guide column 20, even if the power switch 507 on the panel of the controller 5 is turned on, the first killing plate 3 and the second killing plate 4 will not be connected with the power supply, so that human hands can avoid accidentally reaching into the bottom shell 1 and being injured by electric shock. In addition, the guide column 20 is provided to facilitate the quick installation of the upper cover 2 on the bottom shell 1. Because the upper cover 2 can be installed only when the guide column 20 is aligned with the corresponding structure on the bottom shell 1, blind installation can be embodied.

In this embodiment, the first killing plate 3 is a positive metal plate, and the second killing plate 4 is a negative metal plate.

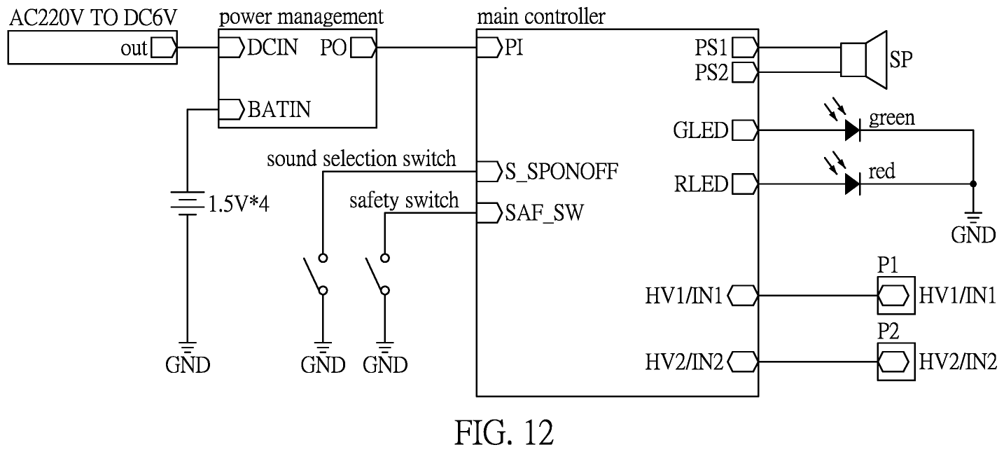

As shown in FIG. 12, the controller 5 includes a main control module, an indicator light and buzzer connected with the main control module, a power management module, a battery and a transformer module connected with the power management module, and a safety switch and a sound selection switch connected with the main control module. The controller uses two electrode outputs (i.e. HV1, HV2/first killing plate 3, second killing plate 4), which is both input and output, meaning that the electrode uses the sensor input as the sensor trigger signal input when it is in standby. When a harmful animal is sensed, the two electrodes are transformed into a high voltage output with a specific waveform to kill the harmful animal that enters through the first killing plate 3 and the second killing plate 4. There are indicator lights and sound prompts after the electric shock, and the sound prompts can be turned on and off by the sound selection switch to adapt to different scenarios. The present disclosure can be powered by AC and DC power sources, AC220V adapter or battery can be used alone, or both can be used at the same time, and the output of the AC adapter can be inserted into the DC input hole 510 on the panel of the shell.

This embodiment takes two entrances 7 as an example for detailed description, but it is obvious that on the basis of this embodiment, those skilled in the art can open the entrances 7 on either side panel, that is, even if one entrance is provided, it is basically able to achieve the effect of the embodiment of the present disclosure. Thus, will not be described in detail here.

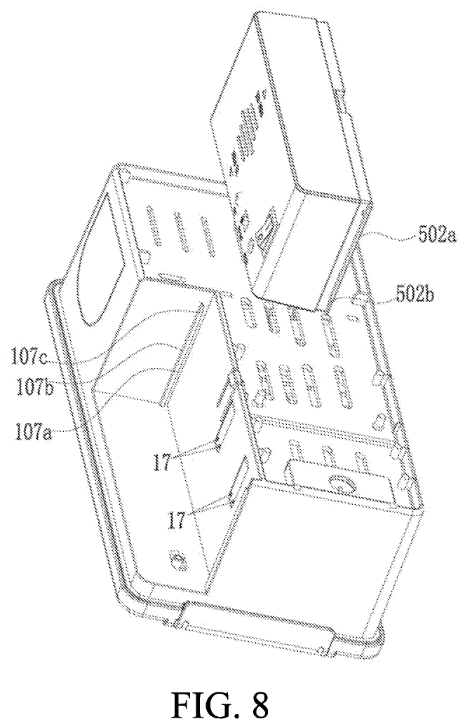

An entrance 7 is provided in one of the side plates or two side plates of the bottom shell 1. Generally, the angle between the bottom plate 101 of the bottom shell 1 of the mousetrap and the side plate is close to 90 degrees, and the central axis of the entrance 7 is the same as the angle formed by the longitudinal centerline of the first killing plate 3 and the second killing plate 4, which is also close to 90 degrees. Therefore, if infants and young children accidentally put their hands into the bottom shell 1, they cannot directly reach the first killing plate 3 like the existing mousetrap, but need to turn to reach the first killing plate 3, which is difficult for infants and young children. Thus, it eliminates potential safety hazards. As shown in FIG. 9, when using a mousetrap, the baffle 8 is opened, the elastic member 9 is squeezed, and small harmful animals such as mice enter the bottom shell 1 from the entrance 7. When the mouse turns and steps on the first killing plate 3 and crosses its hinged end, the first killing plate 3 rotates relative to the bottom plate 101 and the front end of the first killing plate 3 drops, the first elastic member 16 is compressed, and the supporting assembly 13 linked with the first killing plate 3 rotates accordingly. At this time, the baffle 8 loses its support, and under the driver of the elastic member 9, the baffle 8 rotates relative to the first side plate 102 or the second side plate 103, and finally the entrance 7 is closed, thus preventing the mouse from escaping from the bottom shell 1. If the mousetrap is powered on, when the mouse and the first killing plate 3 and the second killing plate 4 are in contact, the mouse can be killed by electric shock. If the mousetrap is not powered on, the mouse will be trapped in the bottom shell 1. When the user looks at it, the trapped mouse will be caught. Therefore, this structural design can have both electric shock and mechanical trapping methods.

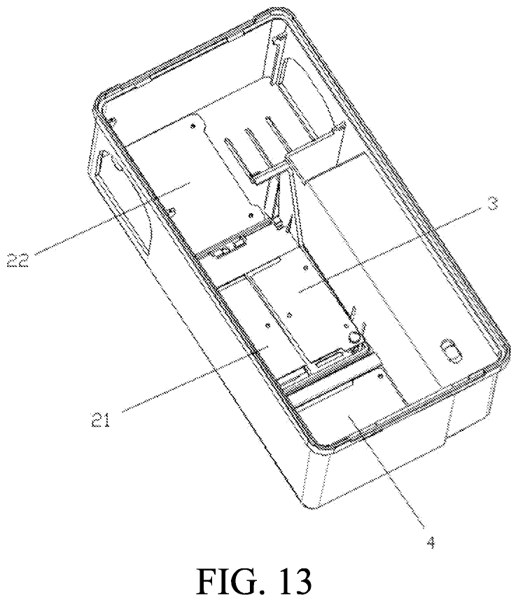

In another embodiment, as shown in FIG. 13, the mousetrap further includes: a third killing plate 21 and a fourth killing plate 22 arranged in the bottom shell 1 and on the bottom plate 101. The third killing plate 21 and the first killing plate 1 are arranged side by side, a hinged end of the third killing plate 21 adjacent to the entrance 7 is also hinged to the bottom shell 1, the third killing plate 21 is also linked with the supporting assembly 13, and the third killing plate 21, and the fourth killing plate 22 are detachably connected with the bottom plate 101. That is, in addition to the detachable first killing plate 3 and the second killing plate 4, the third killing plate 21 and the fourth killing plate 22 are also detachable. When the killing plate is soiled by rat urine and other body fluids, it can be removed and cleaned to avoid the peculiar smell left in the bottom shell 1, thereby affecting the effect of trapping mice.

The above-mentioned descriptions represent merely an exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A mousetrap, comprising:
a bottom shell, an upper cover arranged on the bottom shell, wherein the bottom shell comprises a bottom plate, a first side plate, a second side plate, and a first end plate arranged at one end of the bottom shell;
a first killing plate and a second killing plate arranged in the bottom shell and on the bottom plate, wherein a second end plate is provided at the other end of the bottom shell;
at least one entrance, wherein the entrance is provided inside the first side plate or the second side plate, and a baffle hinged to an inner surface of the first side plate or an inner surface of the second side plate for closing or opening the entrances is provided on the inner surface of the first side plate or the inner surface of the second side plate, a hinged end of the baffle that is hinged to the first side plate or the second side plate is provided with an elastic member configured to drive the baffle to rotate and close the entrance, a hinged end of the first killing plate adjacent to the entrance is hinged to the bottom shell, a first elastic member connected with the first killing plate is provided in the bottom shell, and a supporting assembly linked with the first killing plate is arranged in the bottom shell; when the entrances are in an open state, a lower surface of a side edge of the baffle adjacent to the supporting assembly is supported by the supporting assembly.

2. The mousetrap according to claim 1, wherein one side of the bottom shell is provided with a recessed accommodating part for installing a controller, the controller is provided inside the accommodating part, the accommodating part comprises an inner end plate of which an outer end is connected with an end of the second side plate, an inner side plate of which two ends are respectively connected with an inner end of the inner end plate and the first end plate, and an upper horizontal plate arranged on an upper edge of the inner side plate and extending outward.

3. The mousetrap according to claim 2, wherein the first killing plate and the second killing plate are located between the inner side plate and the first side plate, and are detachably connected with the bottom plate.

4. The mousetrap according to claim 1, wherein two entrances are respectively provided in the first side plate and the second side plate, and a baffle configured to be rotated relative to the inner surface of the first side plate and the inner surface of the second side plate for closing or opening the entrances is respectively provided on the inner surface of the first side plate and the inner surface of the second side plate.

5. The mousetrap according to claim 4, wherein joints of the two baffles with the first side plate and the second side plate are respectively located above the two entrances.

6. The mousetrap according to claim 4, wherein a connecting column is provided on both sides of the hinged end of the two baffles, connecting vertical plates are respectively provided at positions corresponding to the inner surface of the first side plate and the inner surface of the second side plate, each connecting vertical plate is provided with a transverse shaft hole for inserting with the connecting column, and the hinged end of the baffle is located between the two connecting vertical plates.

7. The mousetrap according to claim 4, wherein the hinged ends of the two baffles are each provided with two crossbars located on the same straight line and fixedly connected with the baffle, a gap is between the two crossbars, and the elastic member is a torsion spring with two ends respectively sleeved on the two crossbars; when the entrances are opened, one of torsion arms on the two torsion springs is respectively connected with the inner surface of the first side plate and the inner surface of the second side plate, and the torsion arm is squeezed.

8. The mousetrap according to claim 4, wherein the supporting assembly comprises a vertical plate, a supporting horizontal block fixedly connected with an upper end of the vertical plate, a lateral convex strip provided on a side wall of the supporting horizontal block, and a lower end of the vertical plate is fixedly connected with an end of the first killing plate adjacent to the entrances;
when the entrances are opened, lower surfaces of the side edges of the two baffles adjacent to the supporting horizontal block are placed on an upper surface of the lateral convex strip.

9. The mousetrap according to claim 3, wherein the bottom plate is provided with two bases, two connecting shafts are provided on a hinged end where the first killing plate and the bottom shell are hinged, and the two connecting shafts are respectively hinged with the two bases.

10. The mousetrap according to claim 2, wherein two sets of elastic contacts are provided on an outer wall of the inner side plate and electrically connected with the first killing plate and the second killing plate respectively, and the controller is located in an inner concave portion and detachably connected with the inner side plate.

11. The mousetrap according to claim 10, wherein the controller comprises a shell, a cover plate arranged in the shell, a circuit board and a battery box arranged on the cover plate, a battery arranged in the battery box, and a battery box cover plate arranged at an opening of the battery box, wherein a power switch electrically connected with the circuit board is provided on a panel of the shell.

12. The mousetrap according to claim 11, wherein an upper panel of the shell is provided with a perforation, a safety switch is arranged on the circuit board, an upper end of the safety switch is located in the perforation, the upper horizontal plate is provided with a mounting hole, and the perforation is located directly below the mounting hole.

13. The mousetrap according to claim 11, wherein both ends of the cover plate are provided with a sliding rail integrally formed with the cover plate, an inclined guide surface is provided at an upper end of the sliding rail, two end surfaces of the inner side plate are respectively provided with a sliding groove combined with two sliding rails, and an inner surface of a lower end of an outer barrier strip of the sliding groove is provided with an inclined surface conform to the inclined guide surface.

14. The mousetrap according to claim 11, wherein a buckle plate of which an upper end is fixedly connected with the inner side plate is provided in the inner side plate, two sides and a lower end of the buckle plate are separated from the inner side plate, a lower end surface of the buckle plate is flush with a lower surface of the inner side plate and a fastener is arranged on a lower end surface of the buckle plate, and a buckling gap connected with the fastener is arranged in a lower edge of the cover plate.

15. The mousetrap according to claim 12, wherein an inner surface of the upper cover is provided with two guide columns which are vertical to the inner surface, and when the upper cover is combined with the bottom shell, a lower end of one of the guide columns passes through the mounting hole and presses the safety switch.

16. The mousetrap according to claim 3, further comprising a third killing plate and a fourth killing plate which are arranged in the bottom shell and on the bottom plate, wherein the third killing plate and the first killing plate are arranged side by side, a hinged end of the third killing plate adjacent to the entrance is also hinged to the bottom shell, the third killing plate is also linked with the supporting assembly, and the third killing plate and the fourth killing plate are detachably connected with the bottom plate.
